(19) United States
(12) Patent Application Publication
(10) Pub. No.: US 2015/0246688 A1
(43) Pub. Date: Sep. 3, 2015

(54) HEAVY ROAD VEHICLE WITH NORMAL STEERING AND CRAB STEERING

(71) Applicant: GOLDHOFER AG, Memmingen (DE)

(72) Inventors: Felix Merkel, Memmingen (DE); Benjamin Scholl, Finning (DE)

(73) Assignee: GOLDHOFER AG, Memmingen (DE)

(21) Appl. No.: 14/432,940

(22) PCT Filed: Oct. 1, 2013
(86) PCT No.: PCT/EP2013/070434

§ 371 Date: Apr. 1, 2015

(30) Foreign Application Priority Data
Oct. 2, 2012 (DE) 10 2012 218 047.8

(51) Int. Cl. B62D 7/15

(52) U.S. Cl. CPC B62D 7/1509; B62D 7/1536

(57) ABSTRACT

The invention relates to a heavy goods vehicle in which the steering system (12) comprises, in addition to a normal steering mode steering device (26) that transfers steering power purely mechanically by means of connecting rods (34) from axle to axle, a crab steering mode steering device (28) that can be controlled independently of the normal steering mode steering device (26). The individual wheel assemblies (14, 16, 18, 20, 22, 24) can be connected by means of coupling devices (56) either to the normal steering mode steering device (26) or the crab steering mode steering device (28).

The invention relates to a heavy goods vehicle, comprising
a plurality of axles, each comprising at least one left wheel assembly and at least one right wheel assembly,
a steering system which is designed so that it enables
   both a normal steering mode, in which the left wheel assemblies and the right wheel assemblies each have a steering angle that is dependent on the position of the respective axle in the longitudinal direction of the vehicle, the wheel assemblies of adjacent axles having a different steering angle from one another,
   and a crab steering mode, in which the wheel assemblies assigned to the plurality of axles all have the same steering angle.

The term “heavy goods vehicle” in the present invention relates to both self-propelled heavy goods vehicles and heavy goods trailers.

Heavy goods trailers or “trailers for transporting heavy loads” as defined in Annex XI of EU-Guideline 2007-46-EC in the version dated 15.07.2011 are class O₄ vehicles according to the definition of this term therein for the transportation of indivisible loads (for example the rotor blades of wind turbines), which are subject to speed and traffic restrictions because of their dimensions. A similar definition also applies to self-propelled heavy goods vehicles.

The heavy goods trailer according to the invention can be both a heavy goods trailer with a drawbar and a heavy goods semitrailer. In addition, the heavy goods trailer according to the invention can have a modular structure regardless of the number of modules.

If one of the modules of such a modular heavy goods trailer is equipped with a so-called “power pack”, in which a combustion engine with a hydraulic pump is arranged, which pump provides the hydraulic volumetric flow for driving the hydraulic motors of the drive axles of the modules, in this way a modular self-propelled vehicle can be formed from a trailing modular vehicle.

Furthermore, it should be noted that in connection with the present invention an “axle” does not necessarily have to be a real, i.e. physically existing axle, as in the example of the rigid axle, but can also denote a virtual axis, which is formed in that the left wheel assembly and the right wheel assembly are arranged relative to the longitudinal axis of the vehicle substantially at the same “height” (i.e. a plane in which both steering rotary axles of the left and right wheel assemblies are orthogonal to the longitudinal axis of the vehicle).

When the term “wheel assembly” is used in connection with the present invention it denotes the wheel assigned to one side of the vehicle or the wheels of the respective vehicle axle assigned to one side of the vehicle and steered together, as well as their respective connection to the vehicle frame. Each wheel can be fitted with one, two or even more tyres.

The steering of a generic heavy goods vehicle needs to fulfil many requirements. On the one hand the vehicle has to be roadworthy and therefore satisfy the relevant legal requirements, for example the European regulations on motor vehicles and their trailers (ECE Regulations) and German road traffic licensing regulations (StVZO). This is made possible by means of a normal steering mode which meets said requirements and determines the steering angle of the individual wheel assemblies, for example according to the Ackermann principle. In the purest form of the Ackermann principle the steering angle of each individual wheel assembly is adjusted so that ideally the extensions of the wheel axles of all wheel assemblies meet at a single point, the distance of said point from the vehicle longitudinal axis determining the radius of the curve along which vehicle is currently driving. In practice however the Ackermann principle is often approximated in that the wheel assemblies belonging to the same axle are adjusted to the same steering angle and the steering angle of the different axles is selected according to the Ackermann principle.

However, said normal steering mode is often not suitable for manoeuvring at the destination point. Therefore, the vehicle also needs a crab steering mode, in which all of the wheel assemblies of all axles are steered by the same steering angle to enable parallel movements of the vehicle.

The solutions that have been proposed in the prior art so far all have the disadvantage that they are too expensive either in terms of their structure or control technology or do not meet the relevant legal requirements. For example, to transfer the steering powers from axle to axle the connecting elements can be designed to be adjustable in length by means of adjusting units, a control device influencing the length of the individual connecting elements in order to achieve the desired steering mode.

The object of the invention is therefore to develop the generic heavy goods vehicle such that it provides the normal steering mode and the crab steering mode in a structurally simple manner and such that the steering also satisfies the rules of the relevant legal regulations.

Said object is achieved according to the invention by a generic heavy goods vehicle, in which the steering system comprises for each axle at least one rotary steering element which is rotatable about an axis of rotation and is in steering connection with the at least one left wheel assembly and/or the at least one right wheel assembly of the axle, and for each steering rotary element comprises a normal steering mode steering power introduction unit assigned thereto, and for each steering rotary element comprises a crab steering mode steering power introduction unit assigned thereto, and for each steering rotary element comprises a coupling device which connects the steering rotary element in a rotationally engaged manner either to the normal steering mode steering power introduction unit or the crab steering mode steering power introduction unit, the steering system also comprising at least one normal steering mode connecting element which interconnects the normal steering mode steering power introduction units of axles that are adjacent to one another in longitudinal direction of the vehicle, and comprises at least one power device which is arranged on the vehicle and is connected to at least one of the normal steering mode steering power introduction units and provides the steering power for the normal steering operation, and for each wheel assembly comprises a separate power device which is connected to the associated crab steering mode steering power introduction unit and provides the steering power for the crab steering mode.

According to the invention the steering system of the heavy goods vehicle thus has two separate steering devices, namely a normal steering mode steering device and a crab steering mode steering device. With the normal steering mode steering device the steering power is transmitted purely mechanically via the connecting elements from axle to axle, whereas the crab steering mode steering device steers each wheel assembly separately by means of the power device assigned thereto. According to the invention, the connecting elements of the normal steering mode steering device are preferably designed to be rigid in operation. This means that their length does not change during the steering operation. This, however, does not preclude the fact that the length of the connecting elements can be changed as required to determine a desired steering behaviour prior to starting the steering operation.

At least one of the power devices providing the steering power for the crab steering mode can comprise a hydraulic motor. In this case the output shaft of the hydraulic motor can be connected to a drive spindle which meshes with a toothing of the crab steering mode steering power introduction unit. A spindle drive of this kind has a high translation ratio. In this way the required steering power can be provided by means of a comparatively low power hydraulic motor which takes up a small amount of space. In addition, the steering angle can be controlled precisely because of the high translation ratio. Preferably, all of the power devices providing the steering power for the crab steering mode comprise a hydraulic motor.

To achieve the crab steering mode it would be sufficient in principle if the steering angle range of the crab steering mode extended between −90° and +90°. By means of the spindle drive however a steering angle range of between −180° and +180° can also be achieved. Continuous rotation in both directions of rotation is also possible.

The use of hydraulic motors is advantageous in particular for vehicles equipped with a “power pack” (as described above), as the hydraulic volumetric flow necessary for activating the hydraulic motors is provided by the “power pack” anyway.

By means of the at least one coupling device it is possible to switch back and forth between the normal steering mode and the crab steering mode. This simplifies not only the structure of the steering system and thus also the activation of both steering mode types but also satisfies the relevant legal requirements.

In one development of the invention it is proposed that the normal steering mode steering power introduction unit comprises a normal steering mode rotary element assigned to the respective steering rotary element, that the crab steering mode steering power introduction unit comprises a crab steering mode rotary element assigned to the respective steering rotary element, and that the coupling device connects the steering rotary element in a rotationally engaged manner either to the normal steering mode rotary element or the crab steering mode rotary element. This construction has the advantage compared to other constructions of having a simple structure and thus being inexpensive to produce and being unlikely to get dirty. The aforementioned toothing with which the drive spindle of the hydraulic motor meshes can be for example a gear rim formed or arranged on the crab steering mode rotary element.

Preferably, both the normal steering mode rotary element and the crab steering mode rotary element are arranged such that they are rotatable about the axis of rotation of the steering rotary element.

As known per se from the normal steering mode steering device of modular vehicles of the applicant, the steering angles required for the steered axles, more precisely their steering angle ratio, i.e., the ratio of the steering angle to an output variable of the power device can be predetermined in that the free ends of the connecting elements are articulated on the respective normal steering mode rotary element at a predefined radial distance from the axis of rotation of the assigned steering rotary element.

The steering system according to the invention can be used both in vehicles in the normal steering mode steering device of which a common steering rotary element is provided for both wheel assemblies belonging to the same axle (such steering systems are used for example in the heavy goods trailers and heavy goods semitrailers of the applicant: see for example DE 10 2012 205 641) and also in vehicles in which a separate steering rotary element is assigned to each wheel assembly (such steering systems are used for example in the modular vehicles of the applicant).

If the at least one steering rotary element, as known per se from the steering rotary elements of the modular vehicles of the applicant, is part of a rotary frame which also comprises a frame element which is operatively arranged on the frame of the vehicle, the steering rotary element being mounted on the frame element so as to be rotatable about its axis of rotation, said rotary frame can be modified to obtain the present invention such that it also comprises the normal steering mode rotary element and the crab steering mode rotary element, wherein the normal steering mode rotary element and the crab steering mode rotary element are mounted on the frame element so as to be rotatable indirectly or directly about the axis of rotation, for example by means of ball bearings. In this way the frame element can preferably be designed to be annular and connected to the vehicle frame for example by screwing. Furthermore, the normal steering mode rotary element and the crab steering mode rotary element can also be designed to be annular and can form, together with the steering rotary element and the frame element, a multiple rotary ring, preferably a multiple ball slewing ring.

To enable the transfer of the steering power from wheel assembly to wheel assembly it is proposed that the at least one normal steering mode steering power introduction unit has a normal steering mode steering lever to which the at least one normal steering mode connecting element is connected. In order to protect the normal steering mode steering device from external influences, in particular from damage caused by external influences, it is advantageous if the normal steering mode steering lever is arranged, when driving in a straight line, on the side of the steering rotary element pointing towards the vehicle longitudinal centre.

According to the already mentioned “gear rack alternative” the at least one normal steering mode steering power introduction unit could also be configured to have a gear rim, which is in engagement with at least one connecting element in the form of a gear rack.

In one development of the invention it is proposed that the coupling device comprises an adjusting unit which is connected securely to the steering rotary element and a slide which can be displaced by means of the adjusting unit relative to the steering rotary element between a first position and a second position, wherein the slide comprises a first engaging section and a second engaging section, wherein the first engaging section, in the first position of the slide, is in steering power transmission engagement with one of the steering power introduction units, namely the normal steering mode steering power introduction unit or the crab steering mode steering power introduction unit, whereas the second engaging section, in the second position of the slide, is in steering power transmission engagement with the other steering power introduction unit, namely the crab steering mode steering power introduction unit or the normal steering mode steering power introduction unit. In this case the coupling device can be configured as a preassembled assembly and can for this purpose comprise a base element, for example, which can be operatively connected to the steering rotary element. Furthermore, the adjusting unit can be arranged securely on the base element and/or the slide can be guided movably on the base element. Furthermore, the adjusting unit can be a double-acting cylinder piston unit and/or proximity switches can be used to detect reaching the first and second positions.

If the at least one steering rotary element, as described above, is part of a rotary frame and is configured to be substantially annular, the coupling device can be arranged inside the steering rotary element ring. Here it is protected from external influences so that in particular it is possible to prevent damage caused by external influences. Furthermore, the coupling device can act in the axial direction and/or in the radial direction. In addition, it is possible that the coupling device comprises two separately configured coupling units which are, however, synchronised with respect to their mode, one of which is assigned to the normal steering mode steering power introduction unit and the other of which is assigned to the crab steering mode steering power introduction unit.

To enable the free movement of the two steering power introduction units relative to one another it is also possible that the slide comprises a recess adjacent to one of the two engaging sections, which recess enables the free movement of the other steering power introduction unit when said engaging section is in steering power transmission engagement with the assigned steering power introduction unit.

Independently of providing said recess the alternate engagement of the engaging sections with the two steering power introduction units can be achieved in a simple manner in terms of manufacture when the first engaging section and the second engaging section are arranged above one another in the vertical direction of the vehicle.

If the coupling device is arranged inside the annular steering rotary element and the two equally annular steering power introduction units are arranged coaxially with the steering rotary element, the recess in the slide can enable the free rotation of the radially inner steering power introduction unit when the slide is in steering power transmission engagement with the radially outer steering power introduction unit.

To be able to centre the respective steering power introduction unit relative to the slide it is proposed that at least one of the engaging sections is designed to have oblique faces which cooperate with corresponding counter oblique faces of the assigned steering power introduction unit. The steering power transmission engagement between the engaging section considered in this case and the assigned steering power introduction unit is thus substantially play-free.

In order to only have to assign one coupling device to each of the steering rotary elements it is an advantage if for the normal steering mode and the crab steering mode at least one power device is provided for generating the required steering power in each case.

The invention is explained in more detail in the following by way of embodiments with reference to the accompanying drawings, in which:

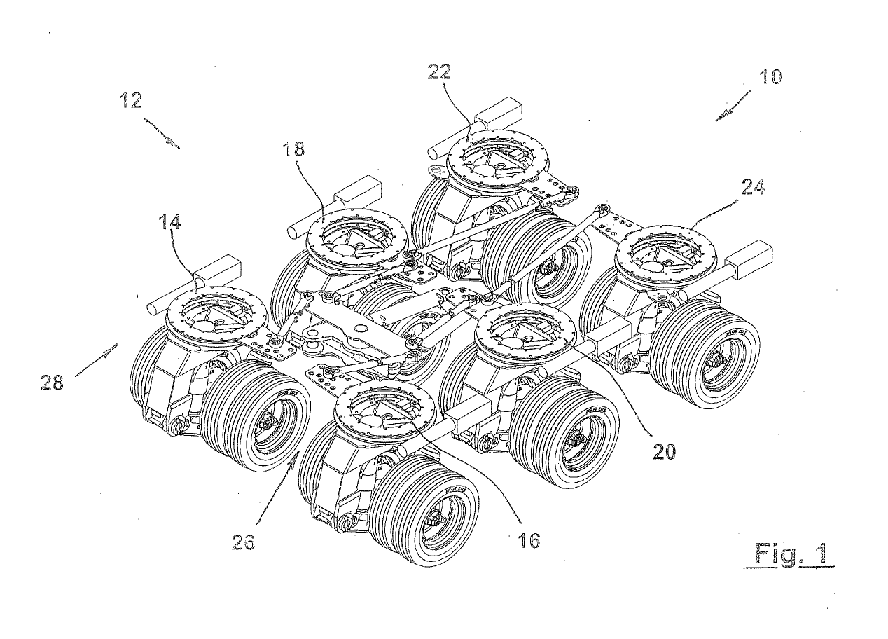

FIG. 1 is a perspective view of the steering system of a vehicle according to the invention, in which the vehicle is illustrated to facilitate the view of the steering system without a vehicle frame and other similar structures;

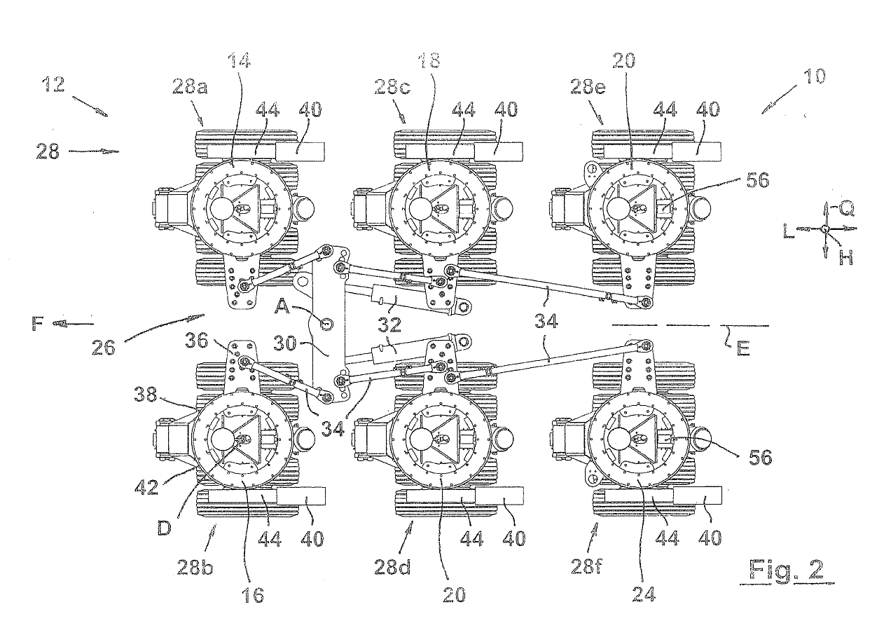

FIG. 2 is a plan view of the steering system according to FIG. 1;

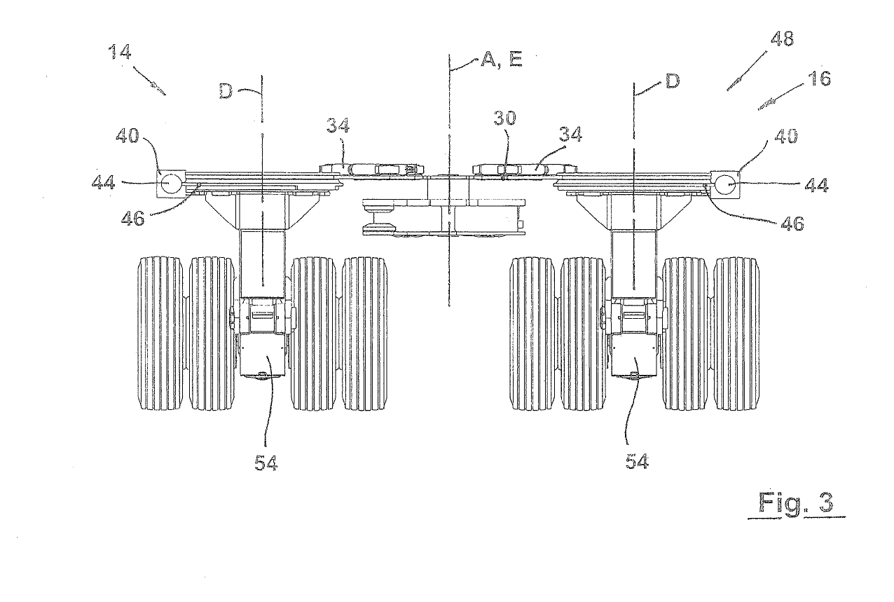

FIG. 3 is a front view of the steering system according to FIG. 1;

FIG. 4 is a perspective view of a single wheel assembly of the vehicle according to the invention;

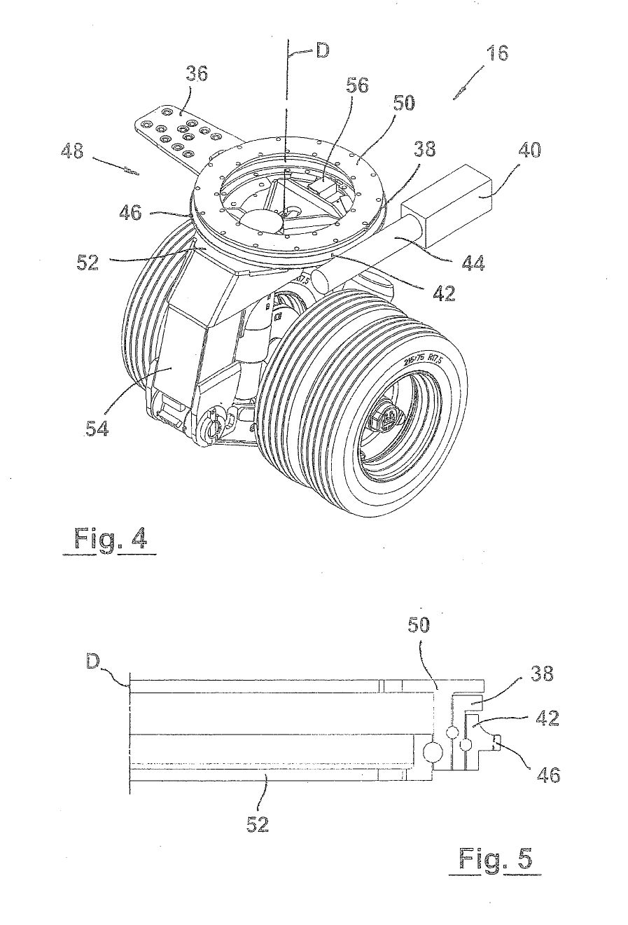

FIG. 5 is a cross section of the multiple-ball slewing ring of the wheel assembly of FIG. 4;

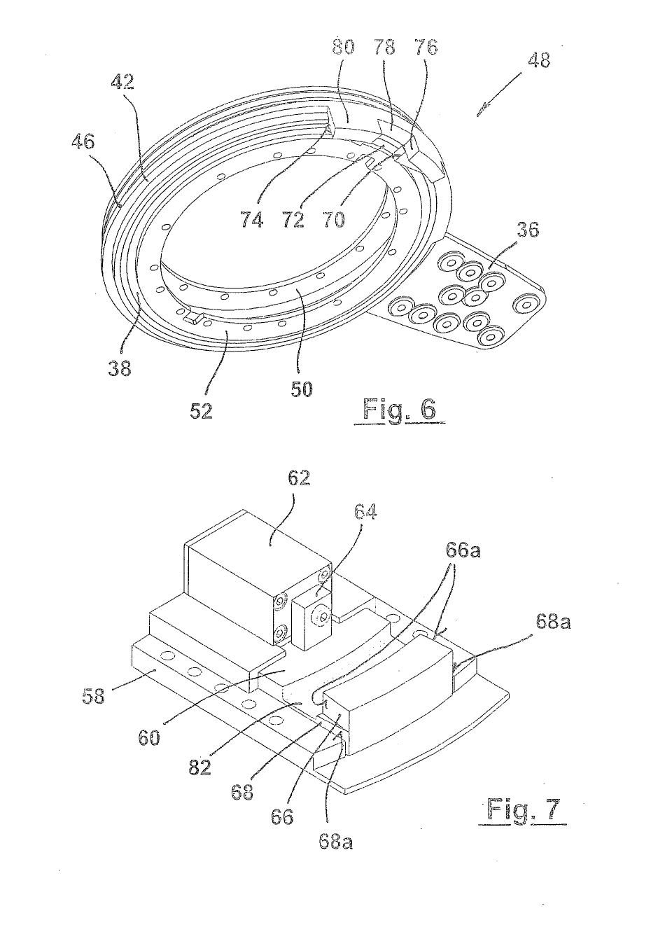

FIG. 6 is a perspective bottom view of the multiple-ball slewing ring of FIG. 5;

FIG. 7 is a perspective view of a coupling device of the wheel assembly of FIG. 4;

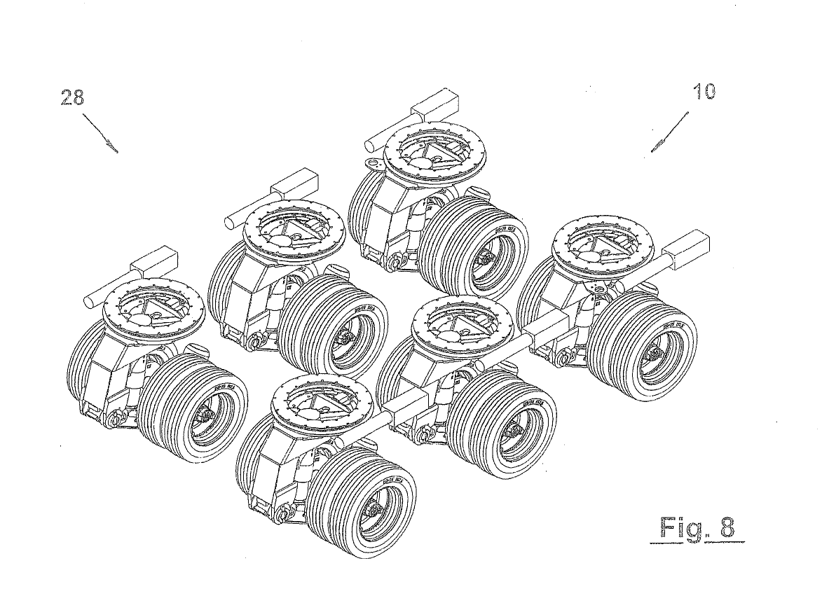

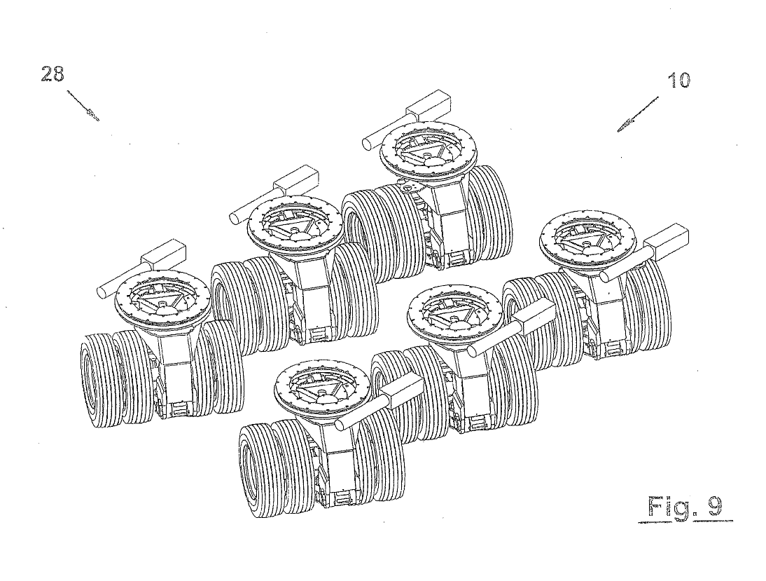

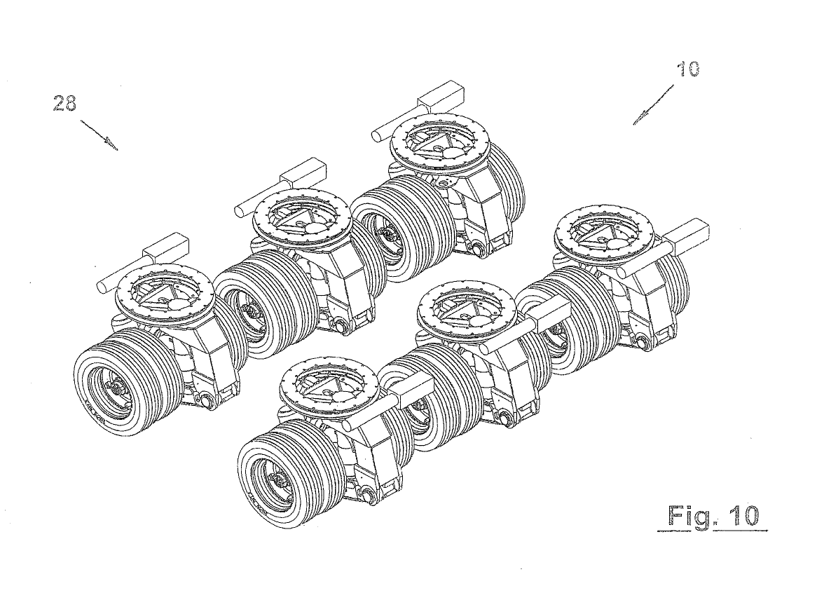

FIGS. 8 to 10 are perspective views similar to FIG. 1—but only of the crab steering device—in three different steering positions, namely FIG. 8 when driving straight ahead, FIG. 9 at a steering angle of about 60° and FIG. 10 at a steering angle of about 90°; and

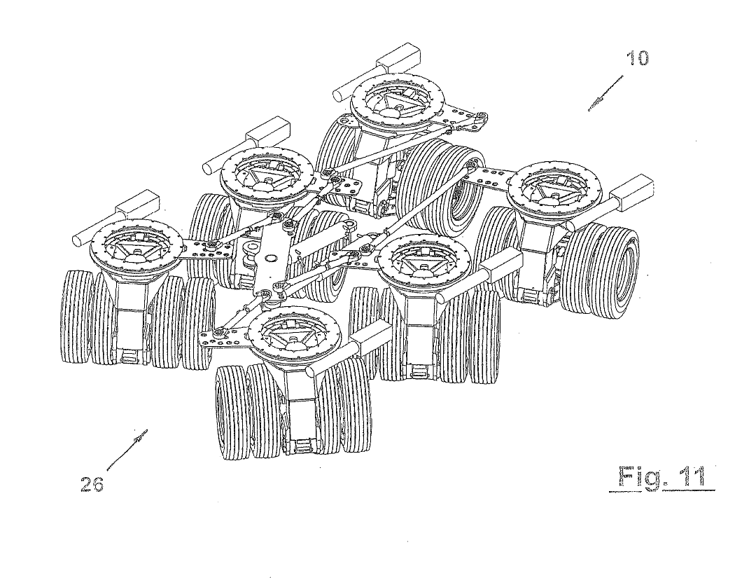

FIG. 11 is a perspective view similar to FIG. 1 in a steering position following a curve during the normal steering mode.

In the following the structure and the function of the heavy goods vehicle according to the invention are explained with reference to an example of a module for a self-propelled or trailing module vehicle.

FIGS. 1 to 3 show a first embodiment of a heavy goods vehicle 10 according to the invention. To provide a better overview only the steering system 12 and the wheel assemblies 14, 16, 18, 20, 22 and 24 are shown, whilst the frame and other structures of the vehicle 10 arranged thereon are not shown. In this case, the wheel assemblies 14, 18, 22 are the right wheel assemblies in relation to the forwards driving direction F of the vehicle 10, whereas the wheel assemblies 16, 20, 24 are the left wheel assemblies. The wheel assemblies 14 and 16 belong to a front axle, the wheel assemblies 18 and 20 to a middle axle and the wheel assemblies 22 and 24 to a rear axle of the vehicle 10.

The steering system 12 comprises a normal steering mode steering device 26 which is configured and designed for driving the vehicle 10 on the public road network and a crab steering mode steering device 28 which is configured and designed for manoeuvring the vehicle 10.

The normal steering mode steering device 26 comprises a pivoting plate unit 30, which can be pivoted by means of two power devices 32, which are formed for example by two hydraulically actuated cylinder piston units, about an axis A which is substantially parallel to the vertical axis H of the vehicle 10. Connecting rods 34 are articulated on the pivoting plate unit 30 and are articulated at their other end to steering levers 36 of steering power introduction units 38 of the wheel assemblies 14, 16, 18, 20. An additional connecting rod 34 connects the steering levers 36 of the steering power introduction units 38 of the wheel assemblies 18 and 22 or 20 and 24. As shown in particular in FIG. 2, the articulation points of the ends of the connecting rods 34 on the steering levers 36 have varying distances from the respective steering axis of rotation D of the associated wheel assemblies. In this way for each wheel assembly a predefined steering behaviour can be determined which is dependent on the steering angle of the pivoting plate unit 30. By selecting suitable distances said steering behaviour can be defined such that the vehicle 10 as a whole exhibits a steering behaviour according to the Ackermann principle (cf. FIG. 14).

According to the embodiment shown in FIGS. 1 to 3 each wheel assembly 14, 16, 18, 20, 22, 24 has a separate crab steering mode steering device 28a, 28b, 28c, 28d, 28e, 28f which together form the (whole) crab steering mode steering device 28. The synchronisation of the crab steering mode steering devices 28a, 28b, 28c, 28d, 28e, 28f of the wheel assemblies 14, 16, 18, 20, 22, 24 can be performed for example by control technology. However it would also be possible to use forced hydraulic synchronisation.

The crab steering mode steering devices 28a, 28b, 28c, 28d, 28e, 28f are all designed to be identical according to the present embodiment. Therefore, in the following only the structure and the function of the crab steering mode steering device 28b of the wheel assembly 16 are described.

The crab steering mode steering device 28b comprises a power device 40 which is arranged on the outside of the vehicle 10 on its frame (not shown) and is in steering power transmission connection with the crab steering mode steering power introduction unit 42 of the wheel assembly 16. For example the power device 40 can be formed by a hydraulic motor. On the output side the power device 40 is connected to a threaded spindle 44 which meshes with a gear rim 46 of the steering power introduction unit 42.

In FIG. 8 the crab steering mode steering device 28 is adjusted so that the vehicle 10 drives in a straight line, i.e. all of the wheel assemblies 14, 16, 18, 20, 22, 24 have the steering angle 0°. In FIG. 9 all of the wheel assemblies have a steering angle of about 60° so that the vehicle 10 drives diagonally forwards or backwards. And in FIG. 10 all of the wheel assemblies are adjusted to a steering angle of 90° so that the vehicle 10 can be moved sideways.

As explained in the following with reference to FIG. 4, which shows the wheel assembly 16 by way of example, the wheel assemblies 14, 16, 18, 20, 22, 24 differ from the wheel assemblies which are used in conventional modular vehicles of the applicant merely on account of the structure of the slewing ring 48.

In particular, the slewing ring 48, which is shown in cross section in FIG. 5 and in perspective in FIG. 6, is configured preferably as a multiple-ball slewing ring. It comprises a frame ring 50 which is secured onto the frame (not shown) of the vehicle 10, for example by screwing, riveting or the like. On the inside of the frame ring 50, the steering rotary element 52 is mounted so as to be rotatable, by means of a schematically indicated ball bearing, about the axis of rotation D of the slewing ring 48 on which the actual wheel mount 54 is secured. The latter has an identical structure to conventional wheel assemblies of the modular vehicles of the applicant and is therefore not described in more detail here. On the outside of the frame ring 50, the likewise annular steering power introduction unit 38 for the normal steering mode is mounted so as to be rotatable about the axis of rotation D by means of a schematically indicated ball bearing, and the likewise annular steering power introduction unit 42 for the crab steering mode is mounted so as to be rotatable about the axis of rotation D by means of a further ball bearing, which is also only schematically indicated. On the outer circumference of the steering power introduction unit 42, the rim gear 46 is formed and is intended to engage in a meshing manner with the threaded spindle 44 of the power device 40.

In principle it would be sufficient for the crab steering mode steering device 28 for the wheel assemblies 14, 16, 18, 20, 22, 24 to enable a steering angle range between −90° and +90°. To make simple corrective movements an extension of said steering angle range at both limits of 5° to 10° would also be advantageous so that the steering angle range would extend between −100°/−95° and +95°/+100°. However, it is also possible for the steering angle range to extend between −180° and +180°. It is even possible for the wheel assemblies 14, 16, 18, 20, 22, 24 to be rotated in both directions of rotation without limiting the steering angle.

In order to switch back and forth between the normal steering mode and the crab steering mode a coupling device 56 is provided which connects the steering rotary element 52 either to the normal steering mode steering power introduction unit 38 or the crab steering mode steering power introduction unit 42.

In FIG. 7 the structure of the coupling device 56 is illustrated in more detail. It comprises a base plate 58, which is securely connected, in particular is securely screwed, for example to the steering rotary element 52. A slide 60 is mounted on the base plate 58 so as to be displaceable between a first position (in FIG. 7 shown by a solid line) and a second position (in FIG. 7 indicated by a dashed line). An adjusting unit 62 is also secured to the base plate 58 and the adjusting element of the adjusting unit is connected to a tab 64 of the slide 60 in order to move said slide between the first and the second position. The adjusting unit 62 can be for example a double acting hydraulic cylinder piston unit, the end positions of which, corresponding to the first and second positions of the slide 60, can be detected by means of proximity switches. The corresponding detecting signals can be transmitted to a central steering control unit (not shown) which in turn controls the adjusting unit 62.

The slide 60 is designed to have two engaging sections 66 and 68 arranged above one another in the vertical direction H of the vehicle 10. In this case the engaging section 66 for engaging with the lateral delimiting faces 70 of a recess 72 in an engaging tab 74 (cf. FIG. 6) of the steering power introduction unit 38 is set to the normal steering mode, whereas the engaging section 68 for engaging with the lateral delimiting faces 76 of a recess 78 in an engaging tab 80 (cf. FIG. 6) of the steering power introduction unit 38 is set to the crab steering mode. If the slide 60 is in its first position the engaging section 66 is in engagement with the engaging tab 74 of the normal steering mode steering power introduction unit 38, so that the normal steering mode steering device 26 is in steering engagement with the steering rotary element 52 and thus the wheel mount 54. However, if the slide 60 is in its second position the engaging section 68 is in engagement with the engaging tab 80 of the crab steering mode steering power introduction unit 42, so that the crab steering mode steering device 28 is in steering engagement with the steering rotary element 52 and thus the wheel mount 54. To ensure that the engaging tab 74 does not hinder the free rotation of the crab steering power introduction unit 42 in the second position of the slide 60, said tab does not extend as far down in vertical direction H as far as the engaging tab 80, so that it is received in a recess 82 in the slide 60 through which it can move freely.

Furthermore, it should be noted that the engaging sections 66 and 68 are provided with oblique faces 66a, 68a, which are angled in opposite directions to form a wedge, and that the associated delimiting faces 70, 76 are each configured as complementary counter oblique faces. More specifically, the oblique faces 66a of the engaging section 66 extend such that the engaging section 66 on its side facing the adjusting unit 62 is narrower than on its side facing away from the adjusting unit 62. In this way the engaging section 66 can engage with the steering power introduction unit 38 more easily during the movement of the slide 60 from the second position into the first position and can also centre said unit. Furthermore, the steering power introduction unit 38 can be configured to be play-free as a result. In a similar manner the oblique faces 68a of the engaging section 68 extend such that the engaging section 68 is narrower on its side facing away from the adjusting unit 62 than on its side facing the adjusting unit 62. In this way the engaging section 68 can engage with the steering power introduction unit 42 more easily during the movement of the slide 60 from the first position to the second position and can also centre said unit. Furthermore, the steering power introduction unit 42 can be configured to be play-free as a result.

1. Heavy goods vehicle (10) comprising
a plurality of axles, each of which comprises at least one left wheel assembly (16, 20, 24) and at least one right wheel assembly (14, 18, 22),
a steering system (12), which is configured so that it enables both a normal steering mode in which the left wheel assemblies (16, 20, 24) and the right wheel assemblies (14, 18, 22) each have a steering angle which is dependent on the position of the respective axle in the longitudinal direction (L) of the vehicle (10), the wheel assemblies of adjacent axles having a different steering angle from one another, and a crab steering mode in which the wheel assemblies (14, 16, 18, 20, 22, 24) assigned to the plurality of axles all have the same steering angle,
characterised in that
the steering system (12) comprises for each axle:
at least one steering rotary element (52) which is rotatable about an axis of rotation (D) and is in steering connection with the at least one left wheel assembly (16, 20, 24) and/or the at least one right wheel assembly (14, 18, 22) of the axle,
for each steering rotary element (52) a normal steering mode steering power introduction unit (38) assigned thereto,
for each steering rotary element (52) a crab steering mode steering power introduction unit (42) assigned thereto,
for each steering rotary element (52) a coupling device (56), which connects the steering rotary element (52) either to the normal steering mode steering power introduction unit (38) or the crab steering mode steering power introduction unit (42) in a rotationally engaged manner,
the steering system (12) also comprising:
at least one normal steering mode connecting element (34), which connects the normal steering mode steering power introduction units (38) of axles that are adjacent to one another in the longitudinal direction (L) of the vehicle (10),
at least one power device (32) which is arranged on the vehicle and is connected to at least one of the normal steering mode steering power introduction units (38) and provides the steering power for the normal steering mode, and
for each wheel assembly (14, 16, 18, 20, 22, 24) a separate power device (40) which is connected to the associated crab steering mode steering introduction unit (42) and provides the steering power for the crab steering mode.

2. Heavy goods vehicle according to claim 1, characterised in that at least one of the power devices (40) providing the steering power for the crab steering mode, preferably all of said power devices, comprises a hydraulic motor (40).

3. Heavy goods vehicle according to claim 2, characterised in that the output shaft of the hydraulic motor (40) is connected to a drive spindle (44) which meshes with a toothing (46) of the crab steering mode steering power introduction unit (42).

4. Heavy goods vehicle according to claim 1, characterised in that the normal steering mode steering power introduction unit (38) comprises a normal steering mode rotary element assigned to the respective steering rotary element (52), in that the crab steering mode steering power introduction unit (42) comprises a crab steering mode rotary element assigned to the respective steering rotary element (52), and in that the coupling device (56) connects the steering rotary element (52) in a rotationally engaged manner either to the normal steering mode rotary element or the crab steering mode rotary element.

5. Heavy goods vehicle according to claim 1, characterised in that a separate steering rotary element (52) is assigned to the left wheel assemblies (16, 20, 24) and the right wheel assemblies (14, 18, 22) of an axle.

6. Heavy goods vehicle according to claim 4, characterised in that at least one steering rotary element (52) is part of a rotary frame (48) which also comprises a frame element (50) which is operatively arranged on the frame of the vehicle (10), the steering rotary element (52) being mounted on the frame element (50) so as to be rotatable about its axis of rotation (D),
the rotary frame (48) also comprises the normal steering mode rotary element (38) and the crab steering mode rotary element (42), the normal steering mode rotary element (38) and the crab steering rotary element (42) being arranged on the frame element (50) so as to be rotatable indirectly or directly about the axis of rotation (D).

7. Heavy goods vehicle according to claim 1, characterised in that the at least one normal steering mode steering power introduction unit (38) comprises a normal steering mode steering lever (36) to which the at least one normal steering mode connecting element (34) is connected.

8. Heavy goods vehicle according to claim 7, characterised in that, when driving in a straight line, the normal steering mode steering lever (36) is arranged on the side of the steering rotary element (52) pointing towards the longitudinal centre of the vehicle.

9. Heavy goods vehicle according to claim 1, characterised in that the coupling device (56) comprises an adjusting unit (62), which is securely connected to the steering rotary element (52), as well as a slide (60) which can be moved by means of the adjusting unit (62) relative to the steering rotary element (52) between a first position and a second position,
the slide (60) comprising a first engaging section (66) and a second engaging section (68), the first engaging section (66), in the first position of the slide (60), being in steering power transmission engagement with one of the steering power introduction units, namely the normal steering mode steering power introduction unit (38) or the crab steering mode steering power introduction unit,
whilst the second engaging section (68), in the second position of the slide (60), is in steering power transmission engagement with the other steering power introduction unit, namely the crab steering mode steering power introduction unit (42) or the normal steering mode steering power introduction unit.

10. Heavy goods vehicle according to claim 9, characterised in that the slide (60) also comprises a recess (82) adjacent to one (68) of the two engaging sections, which recess enables the free movement of the other steering power introduction unit (38) when said engaging section (68) is in steering power transmission engagement with the associated steering power introduction unit (42).

11. Heavy goods vehicle according to claim 9, characterised in that the first engaging section (66) and the second engaging section (68) are arranged above one another in vertical direction (H) of the vehicle (10).

12. Heavy goods vehicle according to claim 9, characterised in that at least one of the engaging sections (66, 68) is designed to have oblique faces (66a, 68a) which cooperate with corresponding counter oblique faces (70, 76) of the assigned steering power introduction unit (38, 42).
